(19) United States
(12) Patent Application Publication
(10) Pub. No.: US 2011/0173775 A1
(43) Pub. Date: Jul. 21, 2011

(54) PIVOT HINGE WITH MUTUALLY REVERSELY ALLOCATED SPRING TUBES

(76) Inventors: Chia-Hui CHEN, Kwei Shan Hsiang (TW); Tzu-Yu Lin, Kwei Shan Hsiang (TW)

(21) Appl. No.: 12/689,319

(22) Filed: Jan. 19, 2010

(51) Int. Cl. E05D 11/10

(52) U.S. Cl. 16/335

(57) ABSTRACT

A pivot hinge includes: a fixing seat having therein a round hole from which two grooves forming an inversed “V” shape are extended downwards, the grooves include two bevel groove segments extending laterally and obliquely form the central bottom of the round hole to two different directions at the opening of the round hole, and include two vertical groove segments formed on the ends of the bevel groove segments respectively; a shaft of a rotation axle extends into the round hole; and includes: at least two mutually reversely allocated “9” shaped spring tubes each having a slipping over portion over the shaft surface, the portion is formed on its periphery a slit, a lower area of each slipping over portion has a positioning sheet extending downwards obliquely but not radially, each positioning sheet has a bottom vertical portion; the positioning sheets and the vertical portions are slipped respectively in the bevel and the vertical groove segments, an area at an upper area of each positioning sheet contacting with an upper area of a corresponding bevel groove segment forms a surface contacting fulcrum.

### BACKGROUND OF THE INVENTION

1. Field of the Invention

The present invention relates to a pivot hinge with mutually reversely allocated “9” shaped spring tubes, and especially to such a pivot hinge used on a foldable electronic product such as a mobile device like a notebook or a translator machine etc. The foldable electronic product includes a foldable screen and a main body pivotally connected with each other, the pivot hinge is installed at a pivot connecting position in order that the foldable screen can do the function of opening and positioning.

2. Description of the Prior Art

In a preceding US Patent application publication No. 2007/0199180 titled “FORKED SPRING TUBE”, a pivot hinge was disclosed. The pivot hinge includes a fixing seat composed of an assembling portion and a connecting portion, the connecting portion is connected with a main body of a foldable electronic product, while the assembling is provided with a fork-like hole for mating with a forked spring tube, the fork-like hole can be mounted therein with two mutually inversed forked spring tubes; the pivot hinge also includes a rotation axle having a connecting portion connectable with a foldable screen of the foldable electronic product, and includes a shaft extending through an annular slipping over portion of the two forked spring tubes. The structure of the pivot hinge allows the annular slipping over portion of the two forked spring tubes to envelope the shaft of the rotation axle, in order that the foldable screen can be opened to and positioned at any angular position relative to the main body.

By virtue that the forked spring tubes have the annular slipping over portion that envelopes the shaft of the rotation axle, and the annular slipping over portion has on its periphery a slit to be endued with elasticity, the lower area of the slipping over portion has a positioning protruding sheet extending vertically downwards, the bottom of the positioning protruding sheet is formed to have a left and a right bevel portion forking from its middle; the two bevel portions mutually symmetrical are formed at their respective upper areas fulcrums, this will get larger fulcrum areas than that of any conventional technique, and the twisting force that the spring tube can bear can be much increased; after the spring tube is installed in a connecting portion of a fixing seat, it can bear more even force structurally than the prior art, and is not subjected to the problem of loosening.

However, in the disclosed structure of the two forked spring tubes, the two bevel portions forking respectively rightwards and leftward on the bottom of the positioning sheet make the shapes of the entire forked spring tubes become more complicate, and the cost of production of the structure thereby is increased; and by virtue that each forked spring tube has a forked away end, it is harder to be installed in the fixing seat. All these problems are supposed to be solved.

Another prior patent case U.S. Pat. No. 6,170,120 titled “NOTEBOOK COMPUTER HINGE” was mentioned in the above conventional patent application, wherein FIG. 10 discloses a structure of a “9” shaped spring tube, but the lower area of its slipping over portion hasn't a positioning protruding sheet extending vertically downwards, rather, there is a horizontal transverse sheet, thereby the spring tube can not get the effect of fulcrum when it is connected in the fixing seat.

Further, in another prior patent case titled “PIVOT HINGE WITH PLURAL GROOVES” with a Taiwan patent publication No. M368288, a pivot hinge with a plurality of grooves is disclosed, of which a fixing sleeve has therein a plurality of engaging grooves and a plurality of spring tubes correspondent with the engaging grooves in number, a plurality of engaging pieces of the spring tubes are extended respectively into different engaging grooves to make the necks of the spring tubes be allocated in an unaligned mode in order to scatter a springing back force induced during rotating of a pivot axle relatively to the spring tubes. The main point of the patent is to make the plural engaging grooves be allocated to be extended radially, and the engaging pieces of the spring tubes are extended radially from a loop portion and extended in the direction perpendicular to the surface of the loop portion; this may render the areas of the necks to be subjected to being broken by concentrated force exerted thereon, and improvement is wanted for such pivot hinge.

### SUMMARY OF THE INVENTION

The present invention provides a pivot hinge with mutually reversely allocated “9” shaped spring tubes and with a pair of grooves forming an inversed “V” shape, it includes:

a fixing seat being composed of an assembling portion and a connecting portion, wherein the connecting portion is connected with a main body of a foldable electronic product, the assembling portion is provided therein with a round hole from which a pair of grooves forming an inversed “V” shape are extended downwards of its lower edge, the pair of grooves include two bevel groove segments extending laterally and obliquely form the central bottom of the round hole to two different directions at the opening of the round hole, and include two vertical groove segments which are formed on the ends of the bevel groove segments respectively;

a rotation axle having another connecting portion which is connected with a foldable screen, a shaft is extended in a direction opposite to the side where the another connecting portion is, the shaft is extended into the round hole of the fixing seat; and

at least a pair of mutually reversely allocated “9” shaped spring tubes which each has an annular slipping over portion for slipping over the surface of the shaft, the annular slipping over portion is formed on the periphery thereof a slit to endue the annular slipping over portion with elasticity over the shaft, the lower area of each of the annular slipping over portions has a positioning sheet extending downwards obliquely but not radially, the bottom of the positioning sheet is formed to have a vertical portion; the positioning sheets and their vertical portions are slipped respectively in the bevel groove segments and the vertical groove segments of the mutually inversed “V” shaped grooves of the fixing seat, the contact area at an upper area of each oblique positioning sheet contacting with an upper area of a corresponding bevel groove segment forms a surface contacting fulcrum;

wherein the shaft of the rotation axle is extended through the annular slipping over portions of the mutually reversely allocated “9” shaped spring tubes, taking advantage of the annular slipping over portions tightly enveloping the surface of the shaft, the rotation axle can support the foldable screen to be opened to and positioned at any angular position relatively to the main body.

The above stated novel structure of pivot hinge not only can have better function of fulcrum and have the effects of uniform bearing force and is not subject to loosening as the preceding US patent application publication No. 2007/0199180 titled “FORKED SPRING TUBE” has, but also can have better force bearing effect by having the positioning sheets and the vertical portions which are all perfect planes on the mutually reversely allocated “9” shaped spring tubes, and the shape of it in production can be largely simplified, thus cost of production can be reduced accordingly.

Moreover, in the novel structure of pivot hinge not provided by the present invention, the positioning sheets of the spring tubes are not vertical but bevel, hence the force exerted thereon is scattered to the entire positioning sheets, the areas of the necks are not to be subjected to being broken.

The present invention will be apparent in its structural features and the effect obtained in use after reading the detailed description of the preferred embodiment thereof in reference to the accompanying drawings.

### BRIEF DESCRIPTION OF THE DRAWINGS

FIG. 1 is an anatomic perspective view of the present invention;

FIG. 2 is a perspective view of the present invention after assembling;

FIG. 3 is a sectional view of the present invention;

FIG. 4 is a sectional view taken from a section line A-A in FIG. 3.

### DETAILED DESCRIPTION OF THE PREFERRED EMBODIMENT

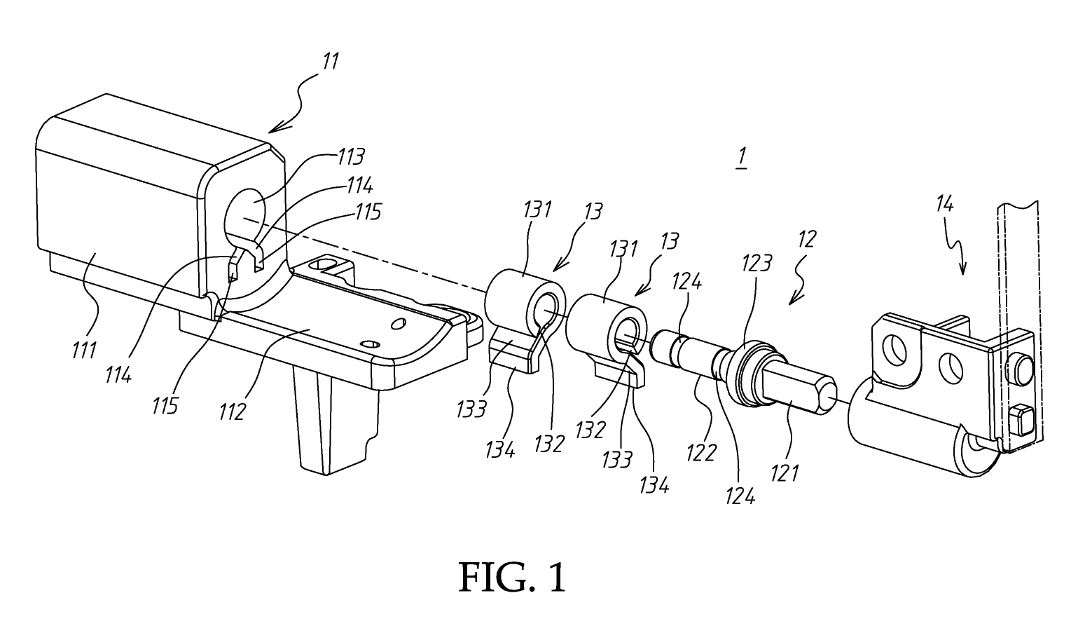

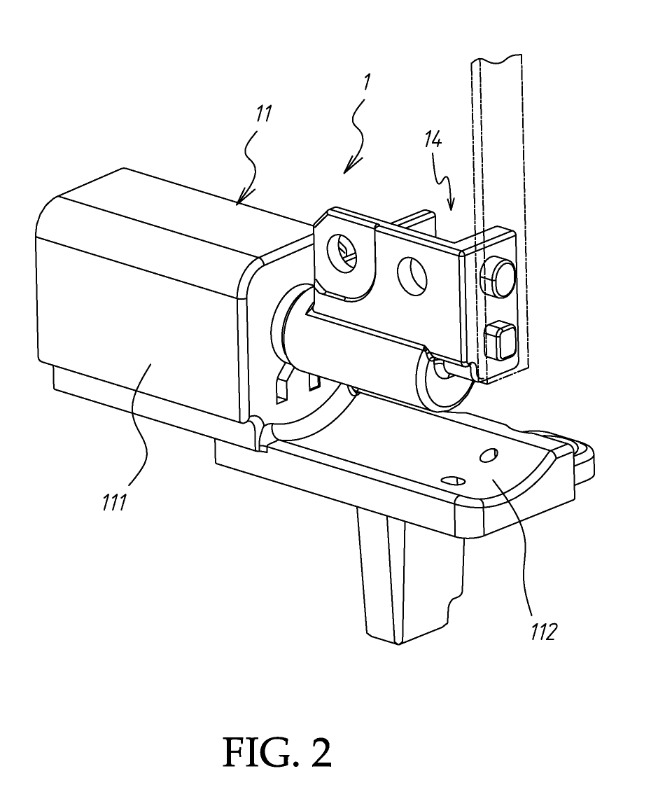

Referring to FIGS. 1 and 2, a pivot hinge 1 with mutually reversely allocated “9” shaped spring tubes provided in the present invention is installed on a foldable electronic product such as a mobile unit like a notebook (not shown), the foldable electronic product includes a foldable screen and a main body (such as a keyboard) pivotally connected with each other, the pivot hinge 1 is installed at a pivotally connecting area. The pivot hinge 1 mainly is composed of a fixing seat 11, a rotation axle 12, a pair of mutually reversely allocated “9” shaped spring tubes 13 and a screen bracket 14.

The fixing seat 11 includes an assembling portion 111 and a connecting portion 112, the connecting portion 112 is connected with a main body of the foldable electronic product, while the assembling portion 111 is in a shape of rectangle; the connecting portion 112 is extended forwards from the bottom edge of the assembling portion 111.

The assembling portion 111 forms therein a round hole 113 from which a pair of grooves forming an inversed “V” shape are extended downwards of its lower edge, the pair of grooves include two bevel groove segments 114 extending laterally and obliquely form the central bottom of the round hole 113 to two different directions at the opening of the round hole 113, and include two vertical groove segments 115 which are formed on the ends of the bevel groove segments 114 respectively.

The rotation axle 12 has another connecting portion 121 which is connected with the screen bracket 14, a shaft 122 is extended in a direction opposite to the side where the another connecting portion 121 is, the shaft 122 is extended into the round hole 113 of the fixing seat 11.

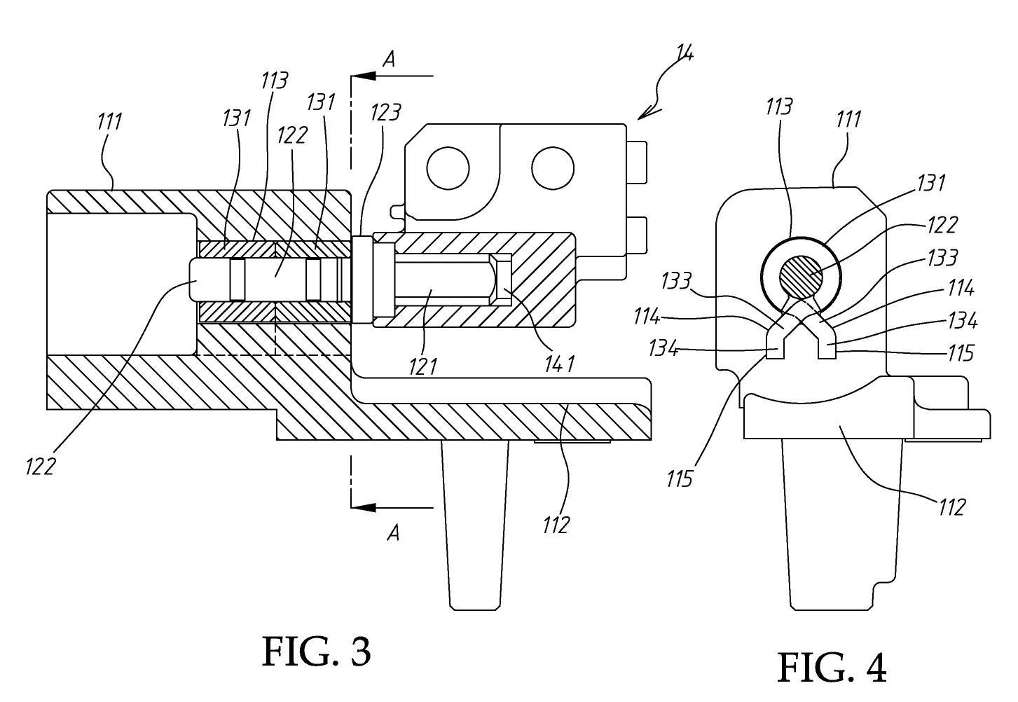

The connecting portion 121 is a non-round-sectional-area rod, it can be connected with a corresponding non-round-sectional-area hole 141 in the screen bracket 14 such as is shown in FIG. 3. The screen bracket 14 can be connected in assembling with the foldable screen. In the foldable electronic equipment, when the foldable screen is opened relatively to the main body, the screen bracket 14 brings the rotation axle 12 to rotate therewith.

A larger portion 123 is formed between the connecting portion 121 and the shaft 122, one side of the larger portion 123 covers the external opening of the round hole 113 of the fixing seat 11 as is shown in FIG. 3.

Each of the pair of mutually reversely allocated “9” shaped spring tubes 13 has an annular slipping over portion 131 for slipping over the surface of the shaft 122, the annular slipping over portion 131 is formed on the periphery thereof a slit 132 to endue the annular slipping over portion 131 with elasticity over the shaft 122. The lower area of each of the annular slipping over portions 131 has a positioning sheet 133 extending downwards obliquely but not radially, the bottom of each positioning sheet 133 is formed to have a vertical portion 134; the positioning sheets 133 and their vertical portions 134 are slipped respectively in the bevel groove segments 114 and the vertical groove segments 115 of the mutually inversed “V” shaped grooves of the fixing seat 11, the contact area at an upper area of each oblique positioning sheet 133 contacting with an upper area of a corresponding bevel groove segment 114 forms a surface contacting fulcrum, such as is shown in FIG. 4.

The shaft 122 of the rotation axle 12 is extended through the annular slipping over portions 131 of the mutually reversely allocated “9” shaped spring tubes 13, taking advantage of the annular slipping over portions 131 tightly enveloping the surface of the shaft 122, the rotation axle 12 can support the foldable screen to be opened to and positioned at any angular position relatively to the main body.

The shaft 122 of the rotation axle 12 further is provided on its surface with a plurality of oil ducts 124 to store lubrication oil for providing a function of lubrication during rotating of the rotation axle 12.

The improved round hole 113, the bevel groove segment 114 and the vertical groove segments 115 in the assembling portion 111 of the fixing seat 11 cooperate with the mutually reversely allocated “9” shaped spring tubes 13 and the rotation axle 12, they not only can have better function of fulcrum and have the effects of uniform bearing force and being not subject to loosening as the preceding US Patent application publication No. 2007/0199180 titled “FORKED SPRING TUBE” being, but also can have better force bearing effect by having the positioning sheets 133 and the vertical portions 134 (which are all perfect planes) on the mutually reversely allocated “9” shaped spring tubes 13, and the shape of it in production can be largely simplified, thus cost of production can be reduced accordingly.

And as compared with the prior patent case titled “PIVOT HINGE WITH PLURAL GROOVES” with a Taiwan patent publication No. M368288, the positioning sheets 133 of the spring tubes 13 of the present invention are not perpendicular but oblique to the annular slipping over portions 131, the force born is scattered to the entire positioning sheets 133, thereby the areas of the necks are not to be subjected to being broken.

What are stated in the specification and shown in the drawings are only for illustrating the preferred embodiment of the present invention, and not for giving any limitation to the scope of the present invention. It will be apparent to those skilled in this art that various equivalent modifications or changes made without departing from the spirit, scope and characteristic of this invention, such as the amount of the mutually reversely allocated “9” shaped spring tubes etc., shall fall within the scope of the appended claims and are intended to form part of this invention.

1. A pivot hinge with mutually reversely allocated “9” shaped spring tubes, being mounted on a foldable electronic product, said foldable electronic product has foldable screen and a main body, said pivot hinge is installed at a pivot connecting position and comprises:
a fixing seat being composed of an assembling portion and a connecting portion, wherein said connecting portion is connected with said main body of said foldable electronic product, said assembling portion is provided therein with a round hole from which a pair of grooves forming an inversed “V” shape are extended downwards of its lower edge, said pair of grooves include two bevel groove segments extending laterally and obliquely form a central bottom of said round hole to two different directions at an opening of said round hole, and include two vertical groove segments which are formed on two ends of said bevel groove segments respectively;
a rotation axle having another connecting portion which is connected with said foldable screen, a shaft is extended in a direction opposite to a side where said another connecting portion is, said shaft is extended into said round hole of said fixing seat; and
at least a pair of said mutually reversely allocated “9” shaped spring tubes which each has an annular slipping over portion for slipping over a surface of said shaft, said annular slipping over portion is formed on a periphery thereof a slit to endue said annular slipping over portion with elasticity over said shaft, a lower area of each of said annular slipping over portions has a positioning sheet extending downwards obliquely but not radially, a bottom of each of said positioning sheet is formed to have a vertical portion; said positioning sheets and said vertical portions are slipped respectively in said bevel groove segments and said vertical groove segments of said mutually inversed “V” shaped grooves of said fixing seat, a contact area at an upper area of each of said oblique positioning sheets contacting with an upper area of a corresponding one of said bevel groove segments forms a surface contacting fulcrum;
wherein said shaft of said rotation axle is extended through said annular slipping over portions of said mutually reversely allocated “9” shaped spring tubes, taking advantage of said annular slipping over portions tightly enveloping surface of said shaft, said rotation axle thus is adapted to supporting said foldable screen to be opened to and positioned at any angular position relatively to said main body.

2. The pivot hinge with mutually reversely allocated “9” shaped spring tubes as claimed in claim 1, wherein said assembling portion of said fixing seat is in a shape of rectangle.

3. The pivot hinge with mutually reversely allocated “9” shaped spring tubes as claimed in claim 2, wherein said connecting portion of said fixing seat is extended forwards from said bottom edge of said assembling portion.

4. The pivot hinge with mutually reversely allocated “9” shaped spring tubes as claimed in claim 1, wherein a larger portion is formed between said connecting portion and said shaft of said rotation axle, one side of said larger portion covers an external opening of said round hole of said fixing seat.

5. The pivot hinge with mutually reversely allocated “9” shaped spring tubes as claimed in claim 4, wherein said connecting portion of said rotation axle is a non-round-sectional-area rod, and is connected with a corresponding non round-sectional-area hole in a screen bracket, said screen bracket is adapted to connecting in assembling with said foldable screen; when said foldable screen is opened relatively to said main body, said screen bracket brings said rotation axle to rotate therewith.

6. The pivot hinge with mutually reversely allocated “9” shaped spring tubes as claimed in claim 4, wherein said shaft of said rotation axle is provided on its surface with a plurality of oil ducts.
